(19) United States
(12) Patent Application Publication
(10) Pub. No.: US 2025/0113847 A1
(43) Pub. Date: Apr. 10, 2025

(54) NATURAL GREEN COLORING EMULSIONS FOR FOODS, DRINKS AND PHARMACEUTICAL PRODUCTS

(71) Applicant: OTERRA A/S, Hørsholm (DK)

(72) Inventors: Luc GANIVET, Hørsholm (DK); Marie DRELON, Hørsholm (DK); Jules HERVE, Hørsholm (DK); Laura GOURY, Hørsholm (DK)

(73) Assignee: Oterra A/S, Hørsholm (DK)

(21) Appl. No.: 18/835,153

(22) PCT Filed: Jan. 16, 2023
(86) PCT No.: PCT/EP2023/050818

§ 371 Date: Aug. 1, 2024

(30) Foreign Application Priority Data
Feb. 4, 2022 (EP) 22155205.2

(51) Int. Cl. A23L 5/43

(52) U.S. Cl. CPC A23L 5/43

(57) ABSTRACT

A natural green liquid coloring composition comprising an oil phase wherein the oil phase comprises a chlorophyll oleoresin. The oil phase is dispersed in a continuous water phase comprising a casein compound as microencapsulating agent.

### FIELD OF THE INVENTION

The invention relates to the field of natural green coloring compositions for food applications. Chlorophylls are widely distributed in green fruits and vegetables. Therefore, chlorophylls can be used as alternatives to artificial colorants through their brilliant green color. Cu-Chlorophyll provides stable green shades. However, Cu-Chlorophyll is not perceived as a natural colour. Consumers are more and more interested in entirely natural colouring compositions for food applications. But natural chlorophylls are raw materials that may contain impurities. This may negatively impact the stability of a natural coloring compositions. In particular, chlorophylls are very sensitive to environmental stresses. For example, browning effects can appear during production processes and in temperature-treated food matrixes. Therefore, there are limitations to the industrial application of chlorophylls as natural colorants.

WO2020210907 to Virentia Innovation discloses a plant macrofibre composition comprising Fabaceae family plant macrofibres and an antioxidant, the composition having a moisture content of about 50 wt. % to about 75 wt. %. However, this patent publication does not disclose natural green composition.

US2020164006A1 to Innovanutra discloses a composition comprising a carrier and a bioactive agent. The bioactive agent is incorporated into the carrier. Sugars from said mixture are preferentially excluded from said carrier. However, this patent publication does not disclose natural green composition.

US20110177202A1 to Wild discloses transparent orange coloring compositions comprising paprika oleoresin containing capsanthin, capsorubin and β-carotene as its main colour constituents. This document further discloses in a generic manner, that oleoresins containing chlorophyll are acquired from the leaves of stinging nettles, spinach, lucerne and/or the mulberry tree. However, there is no example or embodiment relating to a green coloring composition comprising chlorophyll oleoresin.

He et al., Insights into interaction of chlorophylls with sodium caseinate in aqueous nanometre-scale dispersion: color stability, spectroscopic, electrostatic, and morphological properties, RSC Adv. 2019, 9, 4530-4538, discloses a dispersion but not an emulsion. The maximum concentration of chlorophyll of the dispersion is only 0.015% as compared to the total weight of the dispersion.

Therefore, there still is a need for stable and heat-resistant natural green colouring compositions for food applications.

### SHORT DESCRIPTION OF THE INVENTION

The inventors have surprisingly found that formulated Mg-Chlorophyll oleoresin of spinach or alfalfa produces stable green shades in foods even when treated at higher or at lower temperatures. The inventors have further found that such natural green coloring compositions may be stabilized through a natural emulsifier hydrocolloid such as lecithin and a natural antioxidant such as tocopherol. Finally, the inventors suggest a process for the manufacturing of such natural green coloring compositions for food applications.

Accordingly, a first aspect of the present invention is a natural green liquid coloring composition comprising:
an oil phase comprising a chlorophyll oleoresin; and
a continuous water phase comprising a casein compound as microencapsulating agent.

In another aspect, the natural green liquid coloring composition is an emulsion.

In another aspect, the chlorophyll oleoresin is derived from alfalfa or spinach. In another aspect, the chlorophyll content of the composition is from 0.2 w % or more, preferably from 0.4 w %, even more preferably from 0.55 w % or more. In another embodiment, the chlorophyll content of the composition is from 20 w % or less, preferably, 15 w % or less, even more preferably 10 w % or less, even more preferably 5 w % or less. In another embodiment, the chlorophyll content of the composition is from 0.2 w % to 2 w %, preferably from 0.4 w % to 1 w % and even more preferably from 0.55 w % to 0.75 w %. In another aspect, the chlorophyll oleoresin is present in an amount of from 5 w % to 30%, preferably from 10 w % to 25 w %, even more preferably from 13 w % to 22 w % as compared to the total weight of the natural green liquid coloring composition.

In another aspect, the casein compound is native casein.

In another aspect, the casein compound is present in an amount of from 1 w % to 20 w %, preferably from 2 w % to 10 w %, even more preferably from 3 w % to 5 w % as compared to the total weight of the natural green liquid coloring composition.

In another aspect, the weight ratio of the chlorophyll oleoresin to the casein compound is from 1:1 to 10:1, preferably from 1:1 to 7:1, even more preferably from 1:1 to 5:1.

In another aspect, the oil phase further comprises an antioxidant.

In another aspect, the antioxidant is tocopherol.

In another aspect, the water phase further comprises an emulsifier.

In another aspect, the emulsifier is lecithin.

In another aspect, the oil phase further comprises a fat selected from the group consisting of sunflower seed oil, corn oil, soybean oil, olive oil, coconut oil, palm oil, palm kernel oil, groundnut oil, cottonseed oil, grape seed oil, rape seed oil, medium-chain triglyceride oils, and combinations thereof.

Another aspect of the invention is a method for manufacturing a natural green liquid coloring composition, comprising the steps of:
dissolving the casein compound and optionally an emulsifier such as lecithin in water;
heating the chlorophyll oleoresin optionally with an antioxidant;
dispersing the heated oil phase in the aqueous phase;
optionally homogenizing the dispersed liquid composition.

Another aspect is a natural green liquid coloring composition which is obtained by the disclosed method of the invention.

Another aspect is the use of the natural green liquid coloring composition of the invention or obtained by the method of the invention for coloring foods, drinks or pharmaceutical products, in particular a pasta product, a bakery product or an ice cream.

Another aspect is a food, in particular a pasta product, a bakery product, dumpling products, rice balls products, cheese products or an ice cream, or drink or a pharmaceutical product, colored by the natural green liquid coloring composition of the invention or obtained by the method of the invention.

### SHORT DESCRIPTION OF THE DRAWINGS

FIG. 1 shows the coloring performance of an exemplary natural green liquid coloring composition comprising Mg-Chlorophyll oleoresin microencapsulated by Ca-caseinate in cake (1B) as compared to the state of the art (1A).

FIG. 2 shows the coloring performance of an exemplary natural green liquid coloring composition comprising Mg-Chlorophyll oleoresin microencapsulated by Ca-caseinate in ice cream (2B) as compared to the state of the art (2A).

FIG. 3 show pasta colored with the natural green liquid coloring composition comprising Mg-Chlorophyll oleoresin microencapsulated by Ca-caseinate.

FIG. 4 show rice balls colored with the natural green liquid coloring composition comprising Mg-Chlorophyll oleoresin microencapsulated by Ca-caseinate.

FIG. 5 show dumplings colored with the natural green liquid coloring composition comprising Mg-Chlorophyll oleoresin microencapsulated by Ca-caseinate.

FIG. 6 show milk colored with the natural green liquid coloring composition comprising Mg-Chlorophyll oleoresin microencapsulated by Ca-caseinate (6B) against natural green liquid coloring composition Mg-Chlorophyll oleoresin microencapsulated by modified starch (6A).

### DETAILED DESCRIPTION OF THE INVENTION

The invention is now described in further details without, however, limiting its scope.

The oil phase of the natural green liquid coloring composition comprises chlorophyll oleoresin.

### Chlorophyll

Chlorophyll is an oil soluble pigment. Chlorophyll may be obtained from Lucerne, nettle, spinach, alfalfa or grass, and preferably is obtained from alfalfa or spinach.

### Chlorophyll Oleoresin

The chlorophyll oleoresin preferably is a Mg chlorophyll oleoresin.

In another embodiment, the chlorophyll oleoresin is not a Cu chlorophyll oleoresin.

The chlorophyll oleoresin is present in an amount of from 5 w % to 30%, preferably from 10 w % to 25 w %, even more preferably from 13 w % to 22 w % as compared to the total weight of the natural green liquid coloring composition.

### Chlorophyll Content in the Final Composition

The natural green liquid coloring composition according to claim 1, wherein the chlorophyll content of the composition is from 0.2 w % to 2 w %, preferably from 0.4 w % to 1 w % and even more preferably from 0.55 w % to 0.75 w % as compared to the total weight of the composition.

### Casein Compound

The casein compound may be natural native casein or modified casein, such as calcium caseinate. The casein compound serves as encapsulating agent for the chlorophyll oleoresin in the natural green liquid coloring composition of the present invention.

The casein compound is present in an amount of from 1 w % to 20 w %, preferably from 2 w % to 10 w %, even more preferably from 3 w % to 5 w % as compared to the total weight of the natural green liquid coloring composition.

In one embodiment, the ratio between the chlorophyll oleoresin and the casein compound is from 1:1 to 10:1, preferably from 1:1 to 7:1, even more preferably from 1:1 to 5:1.

### Antioxidant

The natural green liquid coloring composition may further comprise an antioxidant, such as tocopherol. The antioxidant typically is present in an amount of 0.1 w % to 10 w %, preferably from 0.5 w % to 5 w % and even more preferably form 1 w % to 3 w % as compared to the total weight of the natural green liquid coloring composition.

### Emulsion

In one embodiment, the natural green liquid coloring composition is an emulsion.

In one embodiment, the emulsion comprises insoluble compounds. In another embodiment, the content of insoluble compounds is 10 w % or less, preferably, 7.5 w % or less, even more preferably 5 w % or less, even more preferably 2.5 w % or less, as compared to the total weight of the composition.

In one embodiment, insoluble means insoluble in water. In another embodiment, insoluble means insoluble in oil. In another embodiment, insoluble means insoluble in water and in oil.

### Emulsifier

The natural green liquid coloring composition may further comprise an emulsifier, such as lecithin, preferably sunflower lecithin. The emulsifier typically is present in an amount of 0.01 w % to 1 w %, preferably from 0.05 w % to 0.5 w % and even more preferably form 0.07 w % to 0.3 w % as compared to the total weight of the natural green liquid coloring composition.

### Further Ingredients

The natural green liquid coloring composition may further comprise further ingredients such as sugar. Sugar may be present in an amount of 10 w % to 50 w %, preferably from 20 w % to 40 w % and even more preferably from 25 w % to 35 w % as compared to the total weight of the natural green liquid coloring composition.

The skilled person is able to choose the quantity of the ingredients so that they add up to 100 w %.

### Method of Manufacturing

The method for manufacturing the natural green liquid coloring composition comprises the steps of:
dissolving the casein compound and optionally an emulsifier such as lecithin in water;
heating the chlorophyll oleoresin optionally with an antioxidant;
dispersing the heated oil phase in the aqueous phase; and
optionally homogenizing the dispersed liquid composition.

In one embodiment, the natural green liquid coloring composition is an emulsion. In another embodiment, the chlorophyll content of the natural green liquid coloring composition is from 0.2 w % or more as compared to the total weight of the composition.

### Use of the Natural Green Liquid Coloring Composition for Food Applications Preferably of Food Applications of pH 4 or More

A further aspect of the present invention is the use of the natural green liquid coloring composition for coloring foods, drinks or pharmaceutical products, in particular a pasta product, a bakery product or an ice cream. In one embodiment, the natural green liquid coloring composition is an emulsion. In another embodiment, the chlorophyll content of the natural green liquid coloring composition is from 0.2 w % or more as compared to the total weight of the composition.

The food applications preferably have a pH of 4 or more, preferably, 4.5 or more even more preferably of 5 or more. In another embodiment, the food applications have a pH de 8 or less, preferably, 7 or less even more preferably 6.5 or less.

Finally, the present invention is directed to foods, drinks or pharmaceutical products, in particular a pasta product, a bakery product, a dumpling product, a rice ball, a cheese or an ice cream comprising or colored by the natural green liquid coloring composition.

In one embodiment, the natural green liquid coloring composition is present in an amount from 0.1 w % to 10 w %, preferably from 0.2 w % to 5 w %, even more preferably from 0.5 w % to 2 w % as compared to the total weight of the food product.

### Examples

The following examples illustrate the natural green liquid coloring compositions further without, however, limiting the scope of the invention:

### 1. Exemplary Compositions

The formulations shown in Table 1 have been tested.

TABLE 1
Exemplary compositions of the invention in w %

| Exemplary natural green | | | | | |
|---|---|---|---|---|---|
| liquid coloring | | | | | |
| compositions, hereinafter | | | | | |
| referred to as recipe | 1 | 2 | 3 | 4 | 5 |
| Mg Chlorophyll Alfalfa | 13 | 20 | 22 | | |
| Mg Chlorophyll Spinach | | | | 13 | 13 |
| Water | 48.2 | 43.2 | 43.2 | 48.2 | 48.2 |
| Other ingredients | 34.8 | 32.8 | 30.8 | 34.8 | 34.8 |
| Ca caseinate | 4 | 4 | 4 | 4 | |
| Casein native | | | | | 4 |
| TOTAL | 100 | 100 | 100 | 100 | 100 |

### 2. Manufacturing Process and Analysis

### Process:

An oil phase containing a Mg-Chlorophyll oleoresin is dispersed in a water continuous phase.

### Water Phase:

Casein compound is dissolved in water at 60° C., optionally with other ingredients in a range from 25 to 35% in order to optimize process conditions (for example viscosity) and to increase microbiological stability.

### Oil Phase:

Mg-Chlorophyll oleoresin is heated to 70° C. Other ingredients can be optionally added up to 5% to limit oxidation.

### Emulsion:

The oil phase is dispersed in the water phase. The pH is adjusted to pH 10 with NaOH for microbiological reasons The mixture is then homogenized.

### Analysis

The pigment content in the composition is determined with a UV-spectrophotometer UV-1800 from Shimadzu by dissolving the formulation in water and then acetone at appropriate dilution. The total chlorophyll content is determined at the absorbance 647 nm (chlorophyll a) and 664.5 nm (chlorophyll b) respectively using 17.95 and 7.9 as extinction coefficients.

The lightness, chroma and hue are obtained with a Datacolor 650 in reflexion mode. All the compositions are analyzed in milk 1.5% fat.

3. Color Stability after Heat Treatment-Cake Application

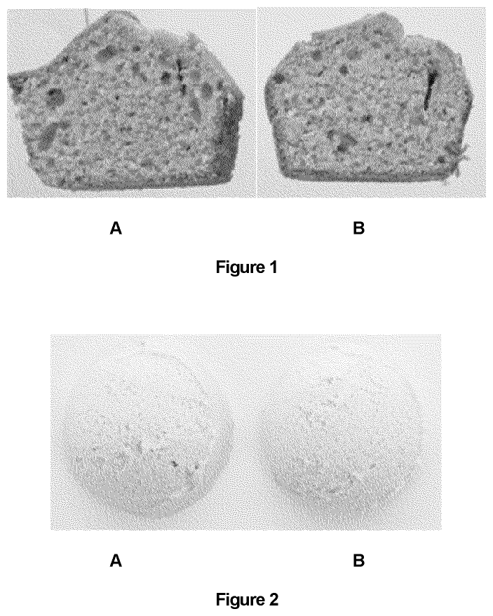

The performance of the natural coloring compositions of recipe 2 in cake is shown in FIG. 1 against a comparative green reference (commercial product based on nettle and spinach concentrate). Cakes colored with the natural coloring compositions of recipe 2 gives an appealing green-yellow color shades, compared to the reference which is more green-bluish.

Method:
Mix 80 g water and 0.45 g potassium sorbate if required
Add 55 g of sunflower oil and color
Add 150 g of cake-mix (containing sugar, wheat flour, wheat starch, whole egg powder, thickener: acetylated di-starch-phosphate, corn starch, raising agents: di-phosphate/sodium carbonate, vegetable emulsifier E471, salt, flavour)
Mix at medium speed with kitchen machine for 2 minutes.
Pour the dough into a greased form.
Bake the cakes in normal oven or convector oven at 180° C. for 30 minutes

FIG. 1A shows cake comprising 1.48% of market reference, which contains 0.4% of pigment.

FIG. 1B shows cake comprising 1.11% of recipe 2, which contains 0.54% of pigment.

### 4. Color Stability—Ice Cream Application

The green reference based on Cu-Chlorophyll gives a less bright and more green-greyish color shade than recipe 2 (FIGS. 2A and B respectively). Indeed, the present invention shows a brighter and green-yellow color shade and a more intense green color, at same color content than the reference.

Method:
Weight the color into a beaker, add the Matilde Ice base and mix it well.
Fill the colored solution into iwaki flasks.
Take photos and perform color measurements using Datacolor 650 and CIE L*a*b*-system by the reflection modus.
Afterwards fill the colored solution into the ice cream engine let it run for 45 minutes (overrun approx. 70%) and freeze it for one night.
Next day take again photos with the ice scoops.

FIG. 2A shows ice cream comprising 0.99% of reference, which contains 0.4 w % of chlorophyll.

FIG. 2B shows ice cream comprising 0.74% of recipe 2, which contains 0.54 w % of chlorophyll.

### 5. Color Stability—Cooked Pasta Application

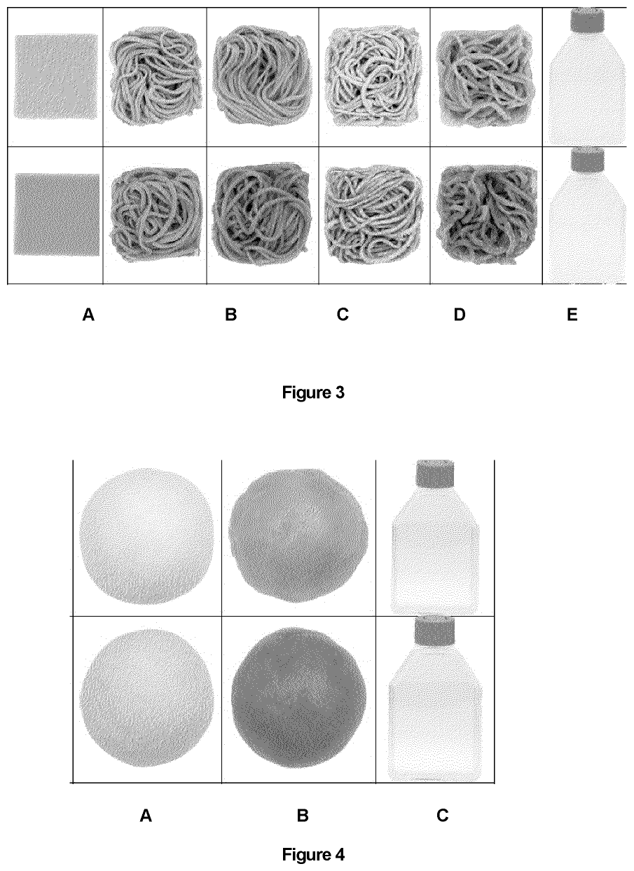

The performance of recipe 4 in pasta is shown in FIG. 3 both uncooked (FIGS. 3A-B) and cooked (FIGS. 3C-D-E). Application tests with an amount of coloring composition of 0.5 w % are presented in top column, and the ones with an amount 1 w % in the lower column.

Nice green color shade in pasta is observed for all samples whatever the cooking process, especially when the dosage is 1 w %. Moreover, no color transfer was noticed in the cooked water, demonstrating the interesting color ability of recipe 4 in this application.

Method of instant noodles:
Weigh 300 grams of flour into the mixing bowl.
Weigh salt, sodium carbonate, potassium carbonate and WS colors, and mix them together with the water.
Start the mixer at low speed and pour the liquid mixture into the flour in a steady stream over 1 minute.
When the mixture has been incorporated into the flour, start the timer for 15 minutes.
When mixing has completed after 15 minutes, scoop out the dough and put it into a zip lock bag and allow the dough to rest for another 15 minutes. This is to allow the gluten network to strengthen.
15 minutes later, compress the dough in the zip lock by using a rolling pin to press the dough down and rolling over it several times until it becomes a thick compact sheet.
Remove the compressed dough from the zip lock, and compound further by rolling it through the widest gap of the pasta machine.
Fold the dough into half and put the dough crumbs in between and roll it through the machine. Do this for about 4-5 times until a neat sheet is achieved.
When the neat sheet has been formed, start reducing the thickness of the sheet by adjusting the gap space gradually from 10 down to 0.
By this time, the dough sheet would be long and thin.
Mount the shredder onto the pasta machine and shred the dough sheet into noodle strands.
For very long strands, cut the strands into desired lengths.
Steam the noodles at 1 atmospheric pressure for 5 minutes.
After steaming, weigh the noodles into 35 g and fit them into the noodle cake moulds.
Deep fry the noodles at 150° C. for 2 minutes.
Extract the noodle cakes from the moulds and rack them to dry and cool down.
Air dry the noodles in oven at 80 C for 30 mins.

FIG. 3A shows the pasta dough prior to cooking.

FIG. 3B shows row noodles prior to cooking.

FIG. 3C shows steamed pasta.

FIG. 3D fried pasta.

FIG. 3E shows boiled pasta.

### 6. Color Stability-Cooked Rice Balls Application

The performance of recipe 4 in rice balls is shown in FIG. 4 both uncooked (FIG. 4 A) and cooked (FIG. 4B). Application tests with an amount of coloring composition of 0.5 w % are presented in top column, and the ones with an amount 1 w % in the lower column.

Nice green color shade in rice balls is observed for all samples, especially when the dosage is 1 w %. Moreover, no color transfer was noticed in the cooked water, demonstrating the interesting color ability of recipe 4 in this application.

Method of rice balls:
Weigh the glutinous rice flour into the mixing bowl.
Weigh the color and add purified water 1 into beaker #1, then mix well.
Add color and purified water 1 into glutinous rice.
Weigh out the purified water 2 into a small beaker #2 and try to wash out all the color in beaker #1.
Mix color solution and glutinous rice flour evenly and check if there are any color spots.

Method of cooking:
Add 500 ml tap water into a pot.
Set the pot on the induction cooker at high power.
Add one rice balls into pot when the water is boiling.
Reduce the power of induction cooker and keep boiling.
Set a timer as 5 minutes.
Scoop up the rice balls once the timer is up and pour out the cooked water.
Take photographs of cooked rice balls and cooked water to see if any color leaches out into the water.

FIG. 4A shows the raw rice ball prior to cooking.

FIG. 4B shows the cooked rice ball.

FIG. 4C shows cooked water.

### 7. Color Stability—Dumplings Application

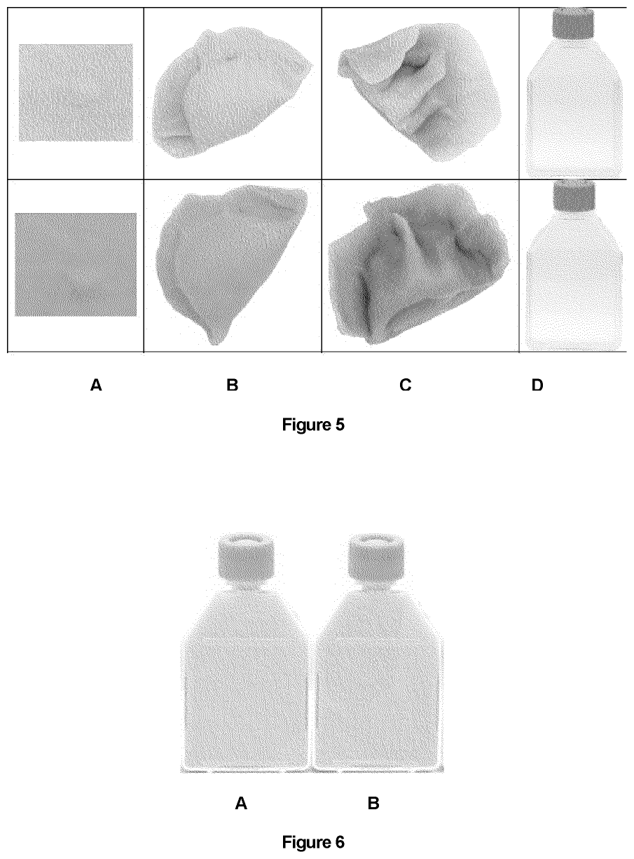

The performance of recipe 4 in dumplings is shown in FIG. 5 both uncooked (FIG. 5B) and cooked (FIG. 5C). Application tests with an amount of coloring composition of 0.5 w % are presented in top column, and the ones with an amount 1 w % in the lower column.

Nice green color shade in dumpling is observed for all samples, especially when the dosage is 1 w %. Moreover, no color transfer was noticed in the cooked water, demonstrating the interesting color ability of recipe 4 in this application.

Method of dumpling:
Weigh the flour into the mixing bowl of kitchen acid and add the salt.
Add the color+water into the flour and mixing with the kitchen aid on speed 2 using the dough hook.
Turn the speed to speed 4 and let the dough mix evenly.
Mix until the dough forms into a ball.
Using the rolling pin, roll out the dough into a big sheet roughly
Using a round shaped cookie cutter/mould e.g., glass, cut out the dough into uniform round pieces.
Make the dumplings with the round pieces, sprinkle flour onto the dumplings to avoid stick to each other.
The dumplings were frozen individually to avoid the dumplings from stick together.

Method of cooking:
Add 500 ml water into a pot.
Add 1 pinch of salt to the water.
Set the pot on the induction cooker at high power.
Once the Water is boiling, reduce the power of the induction cooker so it remains boiling.
Add 1 dumpling to the water and start the timer for 6 minutes. Ensure that the dumpling does not stick to the bottom of the pot.
Once the timer is up, scoop up the dumpling and let it cool

FIG. 5A shows the raw wrapper.

FIG. 5B shows the raw dumpling.

FIG. 5C shows the cooked dumpling.

FIG. 5D shows the cooked water.

8. Comparative Examples with Hydrocolloids

### Compositions

Hydrocolloids were used instead of casein compound to stabilize the composition. All recipes were processed following the different steps below. The formulations shown in Table 2 have been tested but not approved in applications.

TABLE 2
Formulation recipes with hydrocolloids.

Comparative examples

| | 6 | 7 |
|---|---|---|
| | MgC19 116A | MgC19 361 |
| Mg Chlorophyll Alfalfa | 8 | 7.5 |
| Water | 46 | 50.5 |
| Other ingredients | 26 | 22 |
| Modified starch | 20 | |
| Arabic gum | | 20 |
| TOTAL | 100 | 100 |

### Manufacturing Process

An oil phase containing a Mg-Chlorophyll oleoresin is dispersed in a water continuous phase.

### Water Phase:

Hydrocolloid is dissolved in water between 4° and 60° C., optionally with other ingredients

### Oil Phase:

Mg-Chlorophyll oleoresin is heated to 70° C. Other ingredients can be optionally added.

### Emulsion:

The oil phase is dispersed in the water phase. The pH is adjusted to pH 10 with NaOH. The mixture is then homogenized.

### Color Stability—Milk Application

The performance of the recipe 6 in milk is compared to recipe 1 in FIGS. 6, at same pigment content.

Milk colored with the natural coloring composition of example 1 gave a brighter green color shade compared to recipe 6, with hue values of 111, 31 and 107, 66, respectively. Recipe 6 in milk tends to grey shades (FIG. 6A). The Chroma of recipe 6 is duller than recipe 1, with values of 27.07 and 23.36, respectively (Table 3).

TABLE 3
LCh values of recipes 1 and 6 in milk.

| | L | C | h | De2000 |
|---|---|---|---|---|
| Recipe 1 | 75.05 | 27.07 | 111.31 | — |
| Recipe 6 | 77.52 | 23.36 | 107.66 | 2.88 |

FIG. 6A shows milk comprising 0.86% of recipe 6.

FIG. 6B shows milk comprising 0.53% of recipe 1.

The lightness, chroma and hue are obtained with a Datacolor 650 in reflexion mode. All the recipes are analyzed in semi skimmed milk.

1. A natural green liquid coloring composition comprising:
a) an oil phase comprising a chlorophyll oleoresin; and
b) a continuous water phase comprising a casein compound as microencapsulating agent,
wherein the natural green liquid coloring composition is an emulsion;
wherein the chlorophyll content of the natural green liquid coloring composition is from 0.2 w % or more as compared to the total weight of the composition.

2. The natural green liquid coloring composition according to claim 1, wherein the chlorophyll oleoresin is derived from alfalfa or spinach.

3. The natural green liquid coloring composition according to claim 1, wherein the chlorophyll content of the composition is from 0.4 w % to 1 w % and even more preferably from 0.5 w % to 0.8 w % as compared to the total weight of the composition.

4. The natural green liquid coloring composition according to claim 1, wherein the chlorophyll oleoresin is present in an amount of from 5 w % to 30 w %, preferably from 10 w % to 25 w %, even more preferably from 12.5 w % to 22.5 w % as compared to the total weight of the natural green liquid coloring composition.

5. The natural green liquid coloring composition according to claim 1, wherein the casein compound is casein native.

6. The natural green liquid coloring composition according to claim 1, wherein the casein compound is present in an amount of from 1 w % to 20 w %, preferably from 2 w % to 10 w %, even more preferably from 3 w % to 5 w % as compared to the total weight of the natural green liquid coloring composition.

7. The natural green liquid coloring composition according to claim 1, wherein the ratio between the chlorophyll oleoresin and the casein compound is from 1:1 to 10:1, preferably from 1:1 to 7:1, even more preferably from 1:1 to 5:1.

8. The natural green liquid coloring composition according to claim 1, wherein the oil phase further comprises an antioxidant.

9. The natural green liquid coloring composition according to claim 1, wherein the antioxidant is tocopherol.

10. The natural green liquid coloring composition according to claim 1, wherein the water phase further comprises an emulsifier.

11. The natural green liquid coloring composition according to claim 1, wherein the emulsifier is lecithin.

12. A method for manufacturing a natural green liquid coloring, according to claim 1, comprising the steps of:
a. dissolving the casein compound and optionally an emulsifier such as lecithin in water;
b. optionally heating the chlorophyll oleoresin optionally with an antioxidant;
c. dispersing the heated oil phase in the aqueous phase;
d. optionally homogenizing the dispersed liquid composition
wherein the natural green liquid coloring composition is an emulsion;
wherein the chlorophyll content of the natural green liquid coloring composition is from 0.2 w % or more as compared to the total weight of the composition.

13. (canceled)

14. A food, in particular a pasta product, a bakery product, a dumpling product, a rice ball, a cheese, a petfood product, plant-based product or an ice cream, or drink or a pharmaceutical product, colored by the natural green liquid coloring composition claim 1,
wherein the natural green liquid coloring composition is present in an amount from 0.1 w % to 10 w %, preferably from 0.2 w % to 5 w %, even more preferably from 0.5 w % to 2 w % as compared to the total weight of the food product.
